(19) United States
(12) Patent Application Publication
(10) Pub. No.: US 2017/0334353 A1
(43) Pub. Date: Nov. 23, 2017

(54) Parking Assistance System

(71) Applicant: Applications Solutions (Electronic and Vision) Ltd, Lewes (GB)

(72) Inventors: Robert Gillott, Lewes (GB); Eric Hantsch, Brighton (GB); Simon Rafferty, Horsham (GB); Ian Saward, Lewes (GB); Dave Wibberley, Brighton (GB)

(73) Assignee: Applications Solutions (Electronic and Vision) Ltd, Lewes (DE)

(21) Appl. No.: 15/671,066

(22) Filed: Aug. 7, 2017

Related U.S. Application Data
(63) Continuation of application No. PCT/EP2016/050973, filed on Jan. 19, 2016.

(30) Foreign Application Priority Data
Feb. 9, 2015 (EP) 15154255.2

(51) Int. Cl. B60Q 9/00; B62D 15/02; G08G 1/16; G06K 9/00

(52) U.S. Cl. CPC B60Q 9/005; G08G 1/168; B62D 15/0285; G06K 9/00791

(57) ABSTRACT

A parking assistance system for a vehicle includes surround sensors, internal sensors, a data memory, and a processing unit. The surround sensors are configured to provide sensor data of the surrounding of the vehicle. The internal sensors are configured to detect a seat occupancy of passenger seats within the passenger room of the vehicle. The data memory stores a vehicle data model of the vehicle including positions of vehicle doors in the chassis of the vehicle. In addition, the processing unit is configured to process the sensor data received from the surround sensors to calculate an occupancy grid map of the vehicle's surrounding and further configured to calculate disembarking distances for the vehicle doors depending on the vehicle data model, the occupancy grid map and the detected seat occupancy.

### CROSS-REFERENCE TO RELATED APPLICATIONS

This application claims the benefit of PCT International Application No. PCT/EP2016/050973, filed Jan. 19, 2016, which claims priority to European patent application No. 15154255.2 filed Feb. 9, 2015. The disclosures of the above applications are incorporated herein by reference.

### TECHNICAL FIELD

The disclosure relates to an apparatus and a method for performing parking assistance during a parking maneuver of a vehicle.

### BACKGROUND

In many situations, the driver of a vehicle such as a car or a truck has to perform parking maneuvers. After having parked the vehicle in a parking space or parking lot, the parked vehicle may be too close to other objects so that it becomes difficult for passengers of the vehicle to open the vehicle doors sufficiently to leave the car. Furthermore, the doors of the vehicle when opened may damage other objects such as other vehicles that are in close vicinity of the parked vehicle. Moreover, a vehicle door opened by a passenger touching another object can be damaged itself.

### SUMMARY

Accordingly, it is desirable to provide an apparatus and a method that assists the driver of a vehicle when performing a parking maneuver to avoid damages when opening the vehicle doors and to maximize available space for a passenger leaving or entering the vehicle.

As such, one aspect of the disclosure provides a parking assistance system for a vehicle. The parking assistance system includes surround sensors, internal sensors, a data memory, and a processing unit. The surround sensors are configured to provide sensor data of the vehicle's surrounding. The internal sensors are configured to detect a seat occupancy of passenger seats within the passenger room of the vehicle. The data memory stores a vehicle data model of the vehicle including positions of vehicle doors in the vehicle's chassis. The processing unit is configured to process the sensor data received from the surround sensors to calculate an occupancy grid map of the vehicle's surrounding and further configured to calculate disembarking distances for the vehicle doors depending on the vehicle data model, the occupancy grid map, and the detected seat occupancy.

Implementations of this aspect of the disclosure may include one or more of the following optional features. In some implementations, of the parking assistance system, the parking assistance system further includes a display configured to display the calculated disembarking distances during a parking maneuver of the vehicle.

In some examples, the parking assistance system further includes a control unit configured to control a parking maneuver of the vehicle in response to the calculated disembarking distances.

In some implementations, the vehicle data memory is a configurable vehicle data memory including the dimensions of the vehicle's chassis, the positions of the vehicle doors in the vehicle's chassis, the length of the vehicle doors and maximum opening angles of the vehicle doors.

In some examples, the internal sensors are located in the passenger room of the vehicle.

In some examples, the internal sensors include seat sensors integrated in passenger seats and/or seatbelt sensors.

The internal sensors may include at least one internal camera configured to capture camera images of the passenger room.

In some implementations, the seat sensors are configured to provide sensor occupancy data indicating whether the corresponding passenger seats are occupied by a person.

The internal sensors may further provide sensor weight data indicating a weight and/or an approximate size of persons occupying passenger seats.

In some implementations, the processing unit receives further sensor data of child lock sensors indicating whether a child lock at a corresponding vehicle door has been activated.

The surround sensors may include surround view cameras and/or ultrasonic sensors.

In some implementations, the processing unit is configured to evaluate the calculated disembarking distances when the parked vehicle comes to a stand and to output an acoustic and/or an optical warning signal if the calculated disembarking distances are lower than predetermined minimum disembarking distance threshold values.

In In some examples, a vehicle door of the parked vehicle opened by a passenger is locked at a maximum admissible opening angle depending on the calculated disembarking distance at the respective vehicle door.

As a second aspect of the disclosure provides a method for performing parking assistance during a parking maneuver of a vehicle. The method includes providing an occupancy grid map of the vehicle's surroundings. The method also includes detecting a seat occupancy of passenger seats within the passenger room of the vehicle. The method also includes calculating disembarking distances for the vehicle doors of the vehicle depending on the occupancy grid map of the vehicle's surrounding, the detected seat occupancy of the passenger seats and depending on a vehicle data model of the vehicle including positions of the vehicle doors in the vehicle's chassis.

Implementations of this aspect of the disclosure may include one or more of the following optional features. In some implementations, the calculated disembarking distances are displayed during a parking maneuver of the vehicle.

In some examples, the parking maneuver of the vehicle is controlled in response to the calculated disembarking distances.

The calculated disembarking distances may be evaluated when the parked vehicle comes to a stand and an acoustic and/or optical warning signal is output if the calculated disembarking distances are lower than predetermined minimum disembarking distance threshold values.

The details of one or more implementations of the disclosure are set forth in the accompanying drawings and the description below. Other aspects, features, and advantages will be apparent from the description and drawings, and from the claims.

### DESCRIPTION OF DRAWINGS

In the following, possible embodiments of the different aspects of the present disclosure are described with reference to the enclosed figures in more detail.

FIG. 1 shows a block diagram of a possible exemplary embodiment of a parking assistance system according to the first aspect of the present disclosure;

FIG. 2 shows a schematic diagram for illustrating a possible exemplary embodiment of a parking assistance system according to the first aspect of the present disclosure;

FIG. 3 shows a flowchart of a possible exemplary embodiment of a method for performing parking assistance during a parking maneuver of a vehicle according to the second aspect of the present disclosure;

FIGS. 4A, 4B show schematically an exemplary parking maneuver for illustrating the operation of a parking assistance system according to the first aspect of the present disclosure;

FIG. 5 shows a further schematic diagram for illustrating a possible exemplary embodiment of a parking assistance system according to the present disclosure;

FIG. 6 shows a further schematic diagram for illustrating the operation of a possible exemplary embodiment of a parking assistance system according to the first aspect of the present disclosure.

Like reference symbols in the various drawings indicate like elements.

### DETAILED DESCRIPTION

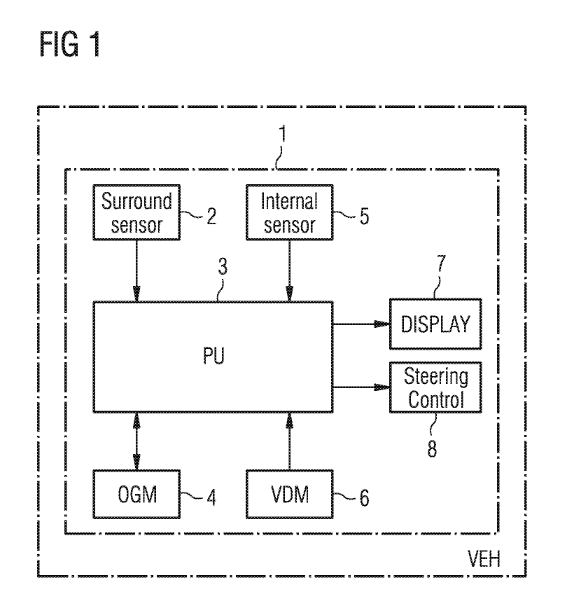

Referring to FIG. 1, in some implementations, a parking assistance system 1 includes i at least one surround sensor 2 configured to provide sensor data of the vehicle's surrounding. The parking assistance system 1 may form part of a driver assistance system of the vehicle VEH. In some examples, the surround sensors 2 include surround view cameras and/or ultrasonic sensors. The parking assistance system 1 includes a processing unit 3 configured to process the sensor data received from the surround sensors 2 to calculate an occupancy grid map OGM of the vehicle's surrounding. The calculated occupancy grid map OGM may be stored in a memory 4 of the parking assistance system 1.

In some implementations, the parking assistance system 1 further includes internal sensors 5 configured to detect a seat occupancy SO of passenger seats within the passenger room PR of the vehicle VEH. In some examples, the internal sensors 5 includes seat sensors 5A, 5B integrated in the passenger seats. The internal sensors 5 may also include at least one internal camera 5C configured to capture camera images of the passenger room PR. For evaluating the camera images CI captured by the internal camera 5C, the image processing entity of the processing unit 3 is configured to extract features from the captured images CI to detect persons sitting within the passenger room PR and to detect a seat occupancy SO of the passenger seats within the passenger room PR of the vehicle VEH. In some implementations, the seat sensors 5A, 5B are integrated in passenger seats 9A, 9B and may provide sensor occupancy data indicating whether the corresponding passenger seat 9A, 9B is occupied by a person P. In some examples, the seat sensors integrated in the passenger seats can provide sensor weight data indicating a weight and/or an approximate size of persons P occupying the corresponding passenger seats.

The parking assistance system 1 as illustrated in FIG. 1 may further include a data memory 6 configured to store a vehicle data model VDM of the vehicle VEH including positions of vehicle doors VDs in the vehicle's chassis. In some examples, the vehicle data model VDM stored in the data memory 6 is configurable via a data interface of the system.

The processing unit 3 of the parking assistance system 1 is configured to process the sensor data received from the surround sensors 2 to calculate the occupancy grid map OGM of the vehicle's surrounding stored in the memory 4 and is further configured to calculate disembarking distances for the vehicle doors VDs of the vehicle VEH depending on the stored vehicle data model VDM, the current occupancy grid map OGM and the current detected seat occupancy SO of the passenger seats within the passenger room PR.

In some implementations, the parking assistance system 1 further includes a display 7 configured to display the calculated disembarking distances during a parking maneuver of the vehicle VEH. In a final phase of the parking maneuver, the driver of the vehicle VEH may monitor the disembarking distances calculated by the processing unit 3 and displayed to the driver on the display 7. When the vehicle VEH comes to a stand, the available disembarking distances are displayed to the driver so that he can decide whether the position of the vehicle VEH allows a disembarking of all passengers P within the vehicle VEH. As shown in FIG. 1, the parking assistance system 1 includes a steering control unit 8 that can perform a steering control for steering support of the vehicle VEH during the parking maneuver. In some examples, the steering control unit is configured to control the parking maneuver of the vehicle VEH in response to the calculated disembarking distances provided by the processing unit 3.

The vehicle data model VDM stored in the data memory 6 may be a configurable vehicle data model corresponding to the type of the vehicle VEH including dimensions of the vehicle's chassis, in particular the positions of the vehicle doors VDs in the vehicle's chassis. The vehicle data model VDM may further includes in a possible embodiment the length of the vehicle doors and/or the maximum opening angles of the vehicle doors.

In some implementations, the processing unit 3 is configured to evaluate the calculated disembarking distances when the parked vehicle VEH comes to a stand and to output an acoustic and/or an optical warning signal via a user interface if the calculated disembarking distances are lower than predetermined minimum disembarking distance threshold values. In some examples, a vehicle door VD of the parked vehicle opened by a passenger P is locked at a maximum admissible opening angle depending on the calculated disembarking distance of the respective vehicle door. The maximum admissible opening angle may be calculated by the processing unit 3 based on the vehicle data of the vehicle data model VDM, for example, based on the vehicle door positions within the vehicle's chassis and the individual length of the vehicle door. In some examples, the processing unit 3 receives further sensor data of child lock sensors indicating whether a child lock at a corresponding vehicle door has been activated. The internal sensors 5 may include seat belt sensors indicating the presence of a passenger P in a corresponding passenger seat. By evaluating the sensor data received by the internal sensors 5 including seat sensors integrated in passenger seats and/or seat belt sensors and/or by evaluating camera images CI generated by internal cameras capturing camera images of the passenger room PR, the processing unit 3 may detect which seats in the passenger room PR are occupied and which seats are not occupied. Internal sensors 5 may provide additional sensor data indicating a weight and/or an approximate size of persons P occupying passenger seats within the passenger room PR.

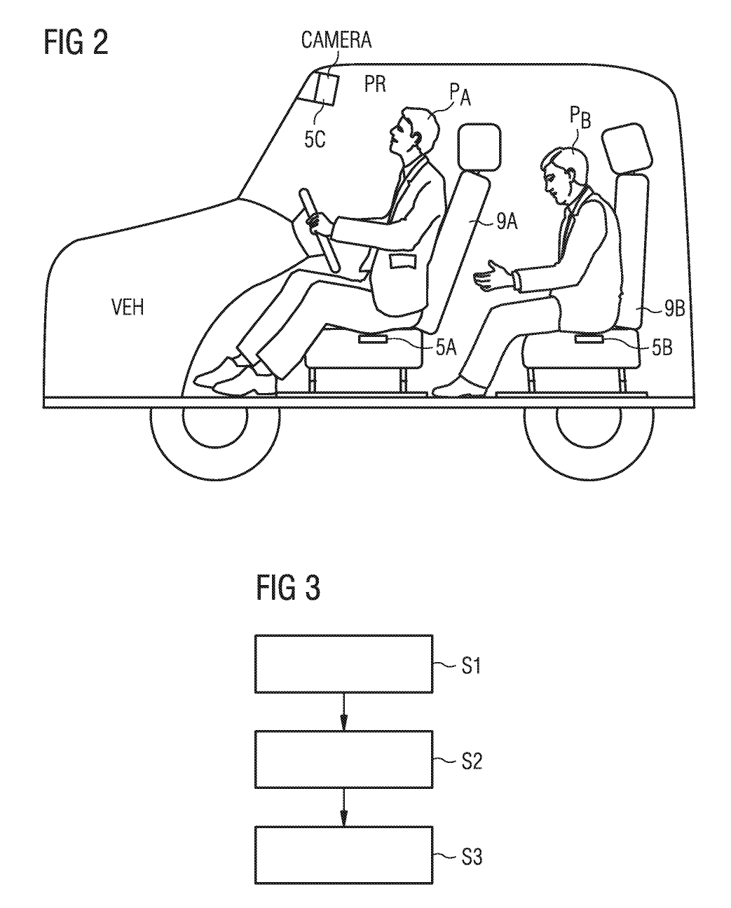

FIG. 2 illustrates schematically a passenger room PR of a vehicle VEH having internal sensors that include seat sensors 5A, 5B integrated in passenger seats 9A, 9B occupied by passengers PA, PB. The first passenger in the front row PA is the driver of the vehicle VEH and steering the vehicle VEH during a parking maneuver. The internal sensors 5 further include an internal camera 5C configured to capture camera images CI of the passenger room PR. The sensor data generated by the internal sensors 5A, 5B, 5C are supplied to the processing unit 3 and processed to determine a seat occupancy SO of the passenger seats within the passenger room PR.

FIG. 3 shows a flowchart for illustrating an exemplary method according to an aspect of the present disclosure.

In a first step S1, an occupancy grid map OGM of the vehicle's surrounding is provided.

In a further step S2, a seat occupancy SO of passenger seats within the passenger room PR of the vehicle VEH is detected.

In a third step S3, disembarking distances of the vehicle doors VDs of the vehicle VEH are calculated depending on the occupancy grid map OGM of the vehicle's surrounding, the detected seat occupancy SO of the passenger seats and depending on the vehicle data model VDM of the vehicle VEH including positions of the vehicle doors VDs within the vehicle's chassis.

Disembarking distances calculated in step S3 may be displayed during a parking maneuver of the vehicle VEH. Further, the calculated disembarking distances can be used to control or influence a parking maneuver in response to the calculated disembarking distances during the parking maneuver.

The calculated disembarking distances can be evaluated when the parked vehicle VEH comes to a stand and can be compared to stored minimum disembarking distance threshold values. If the calculated disembarking distances, after the parking maneuver has been finished and the vehicle VEH comes to a stand, are lower than predetermined minimum disembarking distance threshold values, an acoustic and/or an optical warning signal can be output in a possible embodiment.

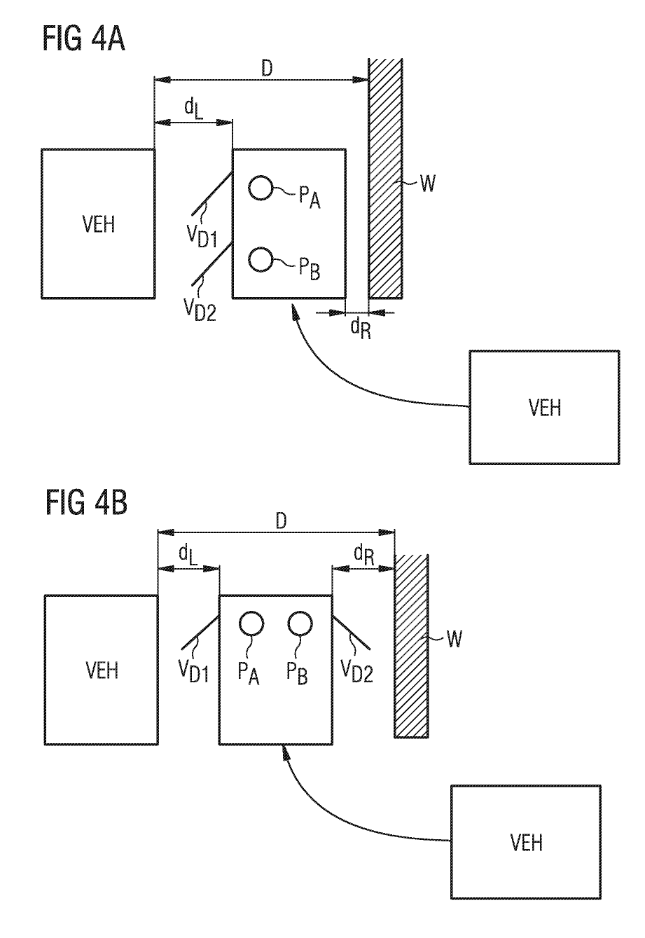

FIG. 4A shows schematically a parking maneuver of a vehicle VEH for illustrating the operation of a parking assistance system 1. As shown in FIG. 4A, the vehicle VEH, including the parking assistance system 1, transports two passengers PA, PB and is driven by the driver PA sitting in the driver's seat into a parking space or parking lot between another vehicle VEH′ and another obstacle such as a wall W. As shown, the detected seat occupancy SO indicates that both passengers PA, PB sit on the left side within the passenger room PR, i.e., the side of the driver's seat. The parking assistance system 1 supports the parking maneuvers such that the vehicle VEH is parked closer to the wall W on the right side so that both passengers PA, PB can disembark the vehicle VEH more easily by opening the vehicle doors VD1, VD2 at a maximum possible opening angle as shown in FIG. 4A. As shown in FIG. 4A, the distance dR between the wall W and the vehicle's chassis is smaller than the distance dL on the left side between the other vehicle VEH′ parked on the left and the vehicle VEH. In this way, the available distance D of the parking space is used in an optimal way and both passengers PA, PB can leave the vehicle VEH with maximum comfort. Moreover, the risk that another vehicle VEH′ is damaged by the opened vehicle doors is minimized.

FIG. 4B illustrates the same parking maneuver as in FIG. 4A with a different seat occupancy SO. In this example, the second passenger PB sits besides the driver in front of the passenger room. In this case, the parking assistance system 1 supports the driving maneuver such that the vehicle VEH is parked in the center between the obstacles defining the parking space. After the parking maneuver, the vehicle VEH is parked such that the distance to the left obstacle dL is equal to the distance dR to the right obstacle W.

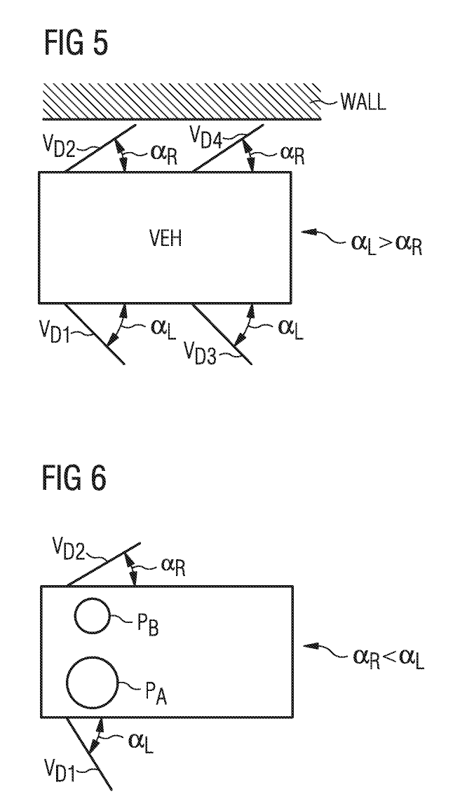

FIG. 5 shows schematically a vehicle VEH that includes a parking assistance system 1 having four vehicle doors VD1, VD2, VD3, VD4. In some implementations, a vehicle door VD of the parked vehicle VEH opened by a passenger P is locked automatically at a maximum admissible opening angle α depending on the calculated disembarking distance at the respective vehicle door VD. As shown in the example of FIG. 5, because of the close wall W, the maximum admissible opening angle of the vehicle doors VD2, VD4 on the right side of the parked vehicle VEH is smaller than the maximum admissible angle of the other two vehicle doors VD1, VD3 on the left side of the vehicle's chassis. Accordingly, passengers P leaving the vehicle VEH on the left side have a maximum available space, thus increasing the comfort of the passengers. By locking the vehicle doors VD2, VD4 at a maximum admissible opening angle on the right side of the vehicle's chassis it is avoided that the vehicle doors VD2, VD4 touch the wall W and may be damaged.

FIG. 6 shows a further schematic diagram of the parking assistance system 1. In the illustrated example, the passenger PA driving the car is an adult accompanied by a smaller person such as a child PB. In some examples, this is detected by the parking assistance system 1 by evaluating sensor weight data indicating a weight of a person P provided for instance by seat sensors integrated in passenger seats. Further, a camera image CI of the passenger room may be evaluated to detect an approximate size of a person P occupying the passenger seats. Depending on the detected size of the person, the parking assistance system 1 calculates necessary opening angles of the vehicle doors which still allow the person P to leave the car. As shown in FIG. 6, the vehicle door VD1 on the left side of the vehicle, i.e., on the driver's side, can be opened to a larger extent with a greater opening angle αL than the other vehicle door VD2 on the right side of the vehicle VEH where the small person PB leaves the vehicle VEH. With continued reference to FIG. 6, the parking assistance system 1 will, during a parking maneuver, assist the driver in parking the vehicle VEH more to the right side leaving more space for the adult driver PA than for the child PB who needs less room to leave the car or vehicle VEH. The method and apparatus according to the present disclosure improves the safety during parking maneuvers and increases the comfort of passengers P entering or leaving a vehicle VEH. The parking of the vehicle VEH too close to other objects or obstacles is avoided and the risk of damages caused by opening doors of the vehicle touching other objects or obstacles is reduced.

A number of implementations have been described. Nevertheless, it will be understood that various modifications may be made without departing from the spirit and scope of the disclosure. Accordingly, other implementations are within the scope of the following claims.

What is claimed is:

1. A parking assistance system for a vehicle comprising:
surround sensors configured to provide sensor data of surroundings of the vehicle;
internal sensors configured to detect a seat occupancy of passenger seats within a passenger room of the vehicle;
a data memory storing a vehicle data model of the vehicle, the vehicle data model is a configurable vehicle data model including dimensions of a chassis of the vehicle, positions of vehicle doors in the chassis of the vehicle, and at least one of a length of the vehicle doors and a maximum opening angles of the vehicle doors; and
a processing unit configured to:
process the sensor data received from the surround sensors to calculate an occupancy grid map of the vehicle's surrounding;
calculate disembarking distances for the vehicle doors depending on the vehicle data model, the occupancy grid map, and the detected seat occupancy; and
calculate a maximum admissible opening angle for the vehicle door of each passenger seat detected as occupied depending on the calculated disembarking distances at the vehicle door.

2. The parking assistance system of claim 1, further comprising a display configured to display the calculated disembarking distances during a parking maneuver of the vehicle.

3. The parking assistance system of claim 1, further comprising a control unit configured to control a parking maneuver of the vehicle in response to the calculated disembarking distances.

4. The parking assistance system of claim 1, wherein the internal sensors are located in the passenger room of the vehicle.

5. The parking assistance system of claim 4, wherein the internal sensors comprise seat sensors integrated in the passenger seats, seat belt sensors and/or at least one internal camera configured to capture camera images of the passenger room.

6. The parking assistance system of claim 5, wherein the seat sensors are configured to provide sensor occupancy data indicating whether a corresponding passenger seat is occupied by a person.

7. The parking assistance system of claim 5, wherein the internal sensors further provide sensor weight data indicating a weight and/or an approximate size of persons occupying passenger seats.

8. The parking assistance system of claim 1, wherein the processing unit receives further sensor data of child lock sensors indicating whether a child lock at a corresponding vehicle door has been activated.

9. The parking assistance system of claim 1, wherein the surround sensors comprise surround view cameras and/or ultrasonic sensors.

10. The parking assistance system of claim 1, wherein the processing unit is configured to:
evaluate the calculated disembarking distances when the parked vehicle comes to a stand; and
output an acoustic and/or an optical warning signal if the calculated disembarking distances are lower than predetermined minimum disembarking distance threshold values.

11. The parking assistance system of claim 1, wherein a vehicle door of the parked vehicle opened by a passenger is locked at a maximum admissible opening angle depending on the calculated disembarking distance at the respective vehicle door.

12. A method for performing parking assistance during a parking maneuver of a vehicle, the method comprising:
providing an occupancy grid map of surroundings of the vehicle;
detecting a seat occupancy of passenger seats within a passenger room of the vehicle;
calculating disembarking distances for vehicle doors of the vehicle depending on the occupancy grid map of the vehicle's surrounding, the detected seat occupancy of the passenger seats and depending on a vehicle data model of the vehicle, wherein the vehicle data model is a configurable vehicle data model including dimensions of a chassis of the vehicle, positions of the vehicle doors in the chassis of the vehicle, and at least one of the length of the vehicle doors and the maximum opening angles of the vehicle doors; and
calculating a maximum admissible opening angle for the vehicle door of each passenger seat detected as occupied depending on the calculated disembarking distance at the vehicle door.

13. The method of claim 12, wherein the calculated disembarking distances are displayed during a parking maneuver of the vehicle and/or wherein a parking maneuver of the vehicle is controlled in response to the calculated disembarking distances.

14. The method of claim 13, wherein the calculated disembarking distances are evaluated when the parked vehicle comes to a stand and an acoustic and/or optical warning signal is output if the calculated disembarking distances are lower than predetermined minimum disembarking distance threshold values.
